(19) United States
(12) Patent Application Publication
(10) Pub. No.: US 2022/0107938 A1
(43) Pub. Date: Apr. 7, 2022

(54) INFORMATION OUTPUTTING DEVICE AND NON-TRANSITORY COMPUTER READABLE MEDIUM

(71) Applicant: FUJIFILM Business Innovation Corp., Tokyo (JP)

(72) Inventor: Takafumi SUZUKI, Kanagawa (JP)

(73) Assignee: FUJIFILM Business Innovation Corp., Tokyo (JP)

(21) Appl. No.: 17/306,280

(22) Filed: May 3, 2021

(30) Foreign Application Priority Data
Oct. 1, 2020 (JP) 2020-167269

(51) Int. Cl. G06F 16/23

(52) U.S. Cl. CPC G06F 16/2379

(57) ABSTRACT

An information outputting device includes: a processor configured to: in modifying a knowledge base that has accumulated various types of knowledge information when knowledge information required for a specific process requested by a user does not correspond to the knowledge accumulated in the knowledge base, acquire difference information that represents a difference between (i) a result of executing the specific process using the pre-modified knowledge base and (ii) a result of executing the specific process using a modified knowledge base; and output the acquired difference information to the user.

### CROSS-REFERENCE TO RELATED APPLICATIONS

This application is based on and claims priority under 35 USC 119 from Japanese Patent Application No. 2020-167269 filed Oct. 1, 2020.

### BACKGROUND

### (i) Technical Field

The present disclosure relates to an information outputting device and a non-transitory computer readable medium.

### (ii) Related Art

Japanese Patent No. 3746233 discloses a knowledge analyzing system which extracts words having emphasis attributes from each of multiple accumulated document information based on emphasis tags embedded in each of the multiple document information to determine a degree of importance of each extracted word based on the type of the emphasis attribute of the word and the appearance frequency of the word, performs a process of accumulating the determination results of the degree of importance for the multiple document information, determines a top predetermined number of words having a high value of the accumulated degree of importance to be important words in the entire multiple document information, and clusters the multiple document information through a comparison between the determined important words in the entire document information and the important words determined from each document information, so as to generate a clustered database in which the multiple document information is classified and arranged.

JP-A-2019-139360 discloses an information providing device which compares a new dictionary obtained by adding a new entity that has not yet been registered in an old dictionary in which one or more entities are already registered to the old dictionary, with specific target contents, extracts entities registered in the new dictionary from the target contents to derive the number of first entities which are registered in the new dictionary and extracted from the target contents, and evaluates the addition of the new entity to the old dictionary based on the derived number of first entities.

Bhavana Dalvi's paper (Bhavana Dalvi et al., “IKE-An Interactive Tool for Knowledge Extraction”, Proceedings of the 5th Workshop on Automated Knowledge Base Construction, Jun. 12-17, 2016) discloses an IKE which is a new extraction tool that performs high-speed interactive bootstrapping, and develops high-quality extraction patterns for target relations, and addresses the concept that an extraction pattern may be treated as a search query for a corpus.

### SUMMARY

When a specific process requested by a user is executed using a knowledge base, the specific process cannot be executed unless knowledge information required for the specific process corresponds to knowledge information accumulated in the knowledge base. Thus, the knowledge base needs to be modified. At that time, when the user is not informed of an influence of the modification of the knowledge base on the specific process, the user may be unable to determine the validity of the modification of the knowledge base in consideration of the influence.

Aspects of non-limiting embodiments of the present disclosure relate to enabling a user to determine the validity of a modification of a knowledge base after the user is aware of an influence of the modification of the knowledge base on a specific process requested by the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information outputting device including: a processor configured to: in modifying a knowledge base that has accumulated various types of knowledge information when knowledge information required for a specific process requested by a user does not correspond to the knowledge accumulated in the knowledge base, acquire difference information that represents a difference between (i) a result of executing the specific process using the pre-modified knowledge base and (ii) a result of executing the specific process using a modified knowledge base; and output the acquired difference information to the user.

### BRIEF DESCRIPTION OF THE DRAWINGS

Exemplary embodiment(s) of the present disclosure will be described in detail based on the following figures, wherein:

FIG. 1 is a view illustrating an outline of an exemplary embodiment of the present disclosure;

FIG. 2 is a view illustrating an example of a hardware configuration of a document management device according to the exemplary embodiment;

FIG. 3 is a block diagram illustrating an example of a functional configuration of the document management device according to the exemplary embodiment;

FIG. 4 is a flowchart illustrating an example of an operation when a knowledge base of the document management device is expanded according to the exemplary embodiment;

FIG. 5 is a flowchart illustrating an example of an operation when a user of the document management device is caused to perform a validation according to the exemplary embodiment;

FIG. 6 is a flowchart illustrating the flow of a degree of contribution calculating process in step 303 of FIG. 5; and

FIG. 7 is a flowchart illustrating the flow of a validation requesting process in step 304 of FIG. 5.

### DETAILED DESCRIPTION

Hereinafter, an exemplary embodiment of the present disclosure will be described in detail with reference to the accompanying drawings.

### Outline of Exemplary Embodiment

An exemplary embodiment of the present disclosure relates to an information outputting device that, in modifying a knowledge base that has accumulated various types of knowledge information when knowledge information required for a specific process requested by a user does not correspond to the knowledge accumulated in the knowledge base, outputs to the user, difference information that represents a difference between (i) a result of executing the specific process using the pre-modified knowledge base and (ii) a result of executing the specific process using a modified knowledge base.

The information outputting device determines whether to modify the knowledge base according to an input of information about the validity of the modification determined by the user after the difference information is output to the user.

Here, the term “specific process” refers to a process executed using the knowledge information accumulated in the knowledge base. Hereinafter, the specific process will be referred to as a “task”. While the task may be a task related to any data such as an image or an application, a task related to documents will be described as an example of the “task” herein below. Examples of the task related to documents include a task of assigning information based on a schema (for example, a category) to documents in a document DB. Hereinafter, the assigned information will be referred to as a “tag”, and this task will be referred to as a “document tagging task”. The examples of the task related to documents also include a task of assigning a relation among documents in the document DB (for example, a reference relation and a dependency). Hereinafter, the assigned relation will be referred to as a “link”, and this task will be referred to as a “document linking task”. The examples of the task related to documents further include a task of searching the document DB for documents useful when the user executes a work, and enumerating the documents. Hereinafter, this task will be referred to as a “document recommendation task”.

The information outputting device may be regarded as a document management device. In the following descriptions, it is assumed that the information outputting device is the document management device.

The term “knowledge information” refers to information usable for efficiently finding out an appropriate solution during execution of the specific process.

The term “knowledge base” refers to a database that collects knowledge information and stores the collected knowledge information in a machine-readable format. Elements of the knowledge base include an ontology that defines data types and a relation between the data types, and entities which are instances of the data types. For example, the ontology defines that there are types of “Person” and “Location”, and a relation of “Is_Born_In” exists between the types. The entities are, for example, “Einstein” and “Germany” which are instances of “Person” and “Location”.

The phrase “when the knowledge information required for the specific process does not correspond to the knowledge accumulated in the knowledge base that has accumulated various types of knowledge information” refers to a case in which the knowledge information required for the specific process is not stored in the knowledge base to be in a state in which the knowledge information required for the specific process is usable for the specific process. Examples of a state in which the knowledge information required for the specific process does not correspond to the knowledge accumulated in the knowledge base that has accumulated various types of knowledge information include a “sparse” state, a “mismatch” state, and an “incorrect” state. The sparse refers to a state in which entities required to execute a task have not been registered, or updating to the entities has not been performed. The mismatch refers to a state in which the premise of the knowledge base does not match the context of a task or a document. The incorrect refers to a state in which an error exists in information already registered in the knowledge base. This state occurs, in particular, when a new document is frequently added to the document DB or when the domain of a document to be analyzed is limited.

The modifying of the knowledge base may include expanding the knowledge base by adding a term and an attribute of the term to the knowledge base. In this case, the term may be either a word or a phrase. In the following description, it is assumed that the term is a “keyword”. Further, the modifying of the knowledge base may include correcting attributes of already registered keywords. Hereinafter, descriptions will be made on an expansion of the knowledge base that newly registers unregistered keywords and attributes of the keywords in the knowledge base.

Further, when the modifying of the knowledge base may be any of the expanding of the knowledge base and the correcting of the knowledge base, the difference information may be information obtained by comparing a result of executing the specific process using the pre-modified knowledge base and a result of executing the specific process using the modified knowledge base.

Meanwhile, when the modifying of the knowledge base is the expanding of the knowledge base, the difference information may be information representing an amount by which the result of executing the specific process using the expanded knowledge base is increased from the result of executing the specific process executed using the pre-expanded knowledge base.

Since the expanding of the knowledge base will be described as an example of the modifying of the knowledge base, the latter information representing the increase amount will be described as the difference information herein below.

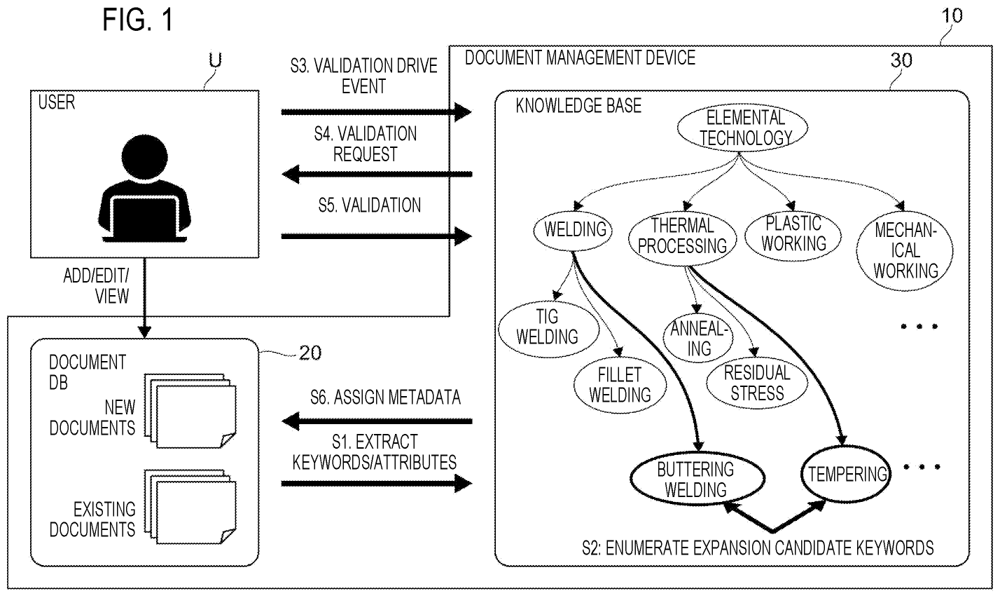

Next, the outline of the present exemplary embodiment will be specifically described. FIG. 1 is a view illustrating the outline of the present exemplary embodiment. Here, the expansion of the knowledge base in the manufacturing industry is described as an example. It is assumed that a document management device 10 includes a document DB 20 in which documents are classified in time series, and thus, stored as new documents and existing documents. Further, it is assumed that the document management device 10 also includes a knowledge base 30 that stores existing knowledge.

First, the document management device 10 extracts keywords and attributes of the keywords that are not registered in the knowledge base 30, from new documents stored in the document DB 20 (S1). Then, the document management device 10 enumerates the keywords extracted in step S1 as candidate keywords for expanding the knowledge base 30 (S2).

In this state, a user U generates a validation drive event (S3). Here, the validation drive event is an operation that triggers the user U to perform a validation. This operation is, for example, an operation in which the user U logs in to the document management device 10, an operation in which the user U interacts with the document management device 10, or an operation that explicitly represents the user U's desire to perform the validation. When the validation drive event is generated in this way, the document management device 10 performs a validation request to the user U (S4). At that time, the document management device 10 presents a task execution result when the knowledge base is updated based on the keywords and the attributes thereof, to the user U. In response, the user U performs the validation to the document management device 10 (S5).

In the validation, when the user U instructs the document management device 10 to add the keywords to the knowledge base 30, the document management device 10 adds the keywords to the knowledge base 30. That is, the document management device 10 presents the task execution result to the user U to guarantee the validity of the update, and adds the keywords to the knowledge base 30. Then, the document management device 10 assigns metadata (for example, tags or links) based on the added keywords, to the documents in the document DB 20 (S6).

### Hardware Configuration of Document Management Device

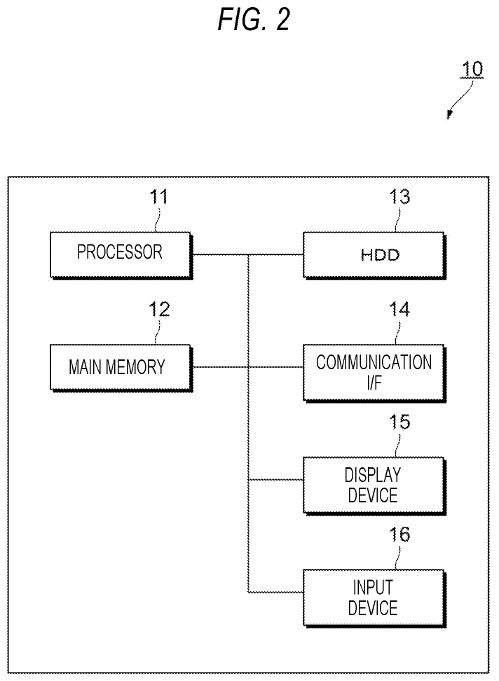

FIG. 2 is a view illustrating an example of a hardware configuration of the document management device 10 according to the present exemplary embodiment. As illustrated, the document management device 10 includes a processor 11, a main memory 12, and an HDD (hard disk drive) 13. Here, the processor 11 executes various types of software such as an OS (operating system) and applications to implement each function to be described later. The main memory 12 is a storage area that stores various types of software, data used for execution of the software, and the like. The HDD 13 is a storage area that stores data input to various types of software or data output from various types of software. Further, the document management device 10 includes a communication I/F (hereinafter, referred to as “I/F”) 14 for communicating with the outside, a display device 15 such as a display, and an input device 16 such as a keyboard or a mouse.

### Functional Configuration of Document Management Device

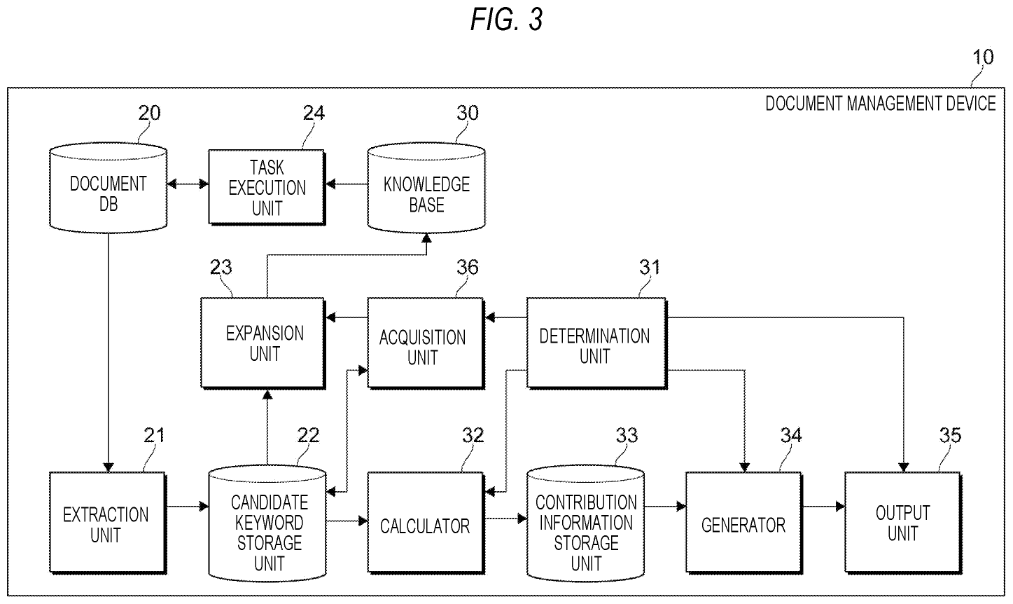

FIG. 3 is a block diagram illustrating an example of the functional configuration of the document management device 10 according to the present exemplary embodiment. As illustrated, the document management device 10 includes the document DB 20 and the knowledge base 30. Further, the document management device 10 includes an extraction unit 21, a candidate keyword storage unit 22, an expansion unit 23, and a task execution unit 24. Further, the document management device 10 includes a determination unit 31, a calculator 32, a contribution information storage unit 33, a generator 34, an output unit 35, and an acquisition unit 36.

The document DB 20 is a database that stores documents managed by the document management device 10. The document DB 20 may store a document together with information on date/time when the document is registered.

The knowledge base 30 stores knowledge information used when a task is executed.

The extraction unit 21 extracts a candidate of a keyword to be added to the knowledge base 30 (hereinafter, referred to as a “candidate keyword”), from the documents stored in the document DB 20. Specifically, the extraction unit 21 may extract a candidate keyword from the documents registered after a previous candidate keyword is extracted. At that time, the extraction unit 21 may extract multiple candidate keywords. The extraction unit 21 may extract the candidate keyword together with an attribute of the candidate keyword.

The candidate keyword storage unit 22 stores the candidate keyword extracted by the extraction unit 21. When the extraction unit 21 extracts the candidate keyword together with the attribute of the candidate keyword, the candidate keyword storage unit 22 also stores the attribute.

The expansion unit 23 expands the knowledge base 30. Specifically, among candidate keywords stored in the candidate keyword storage unit 22, the knowledge base expansion unit 23 adds a candidate keyword for which a feedback acquired by the acquisition unit 36 represents that the candidate keyword needs to be added to the knowledge base 30, to the knowledge base 30.

The task execution unit 24 executes a task related to the documents stored in the document DB 20 by using the knowledge information stored in the knowledge base 30. Here, the task includes, for example, the document tagging task for assigning information on an entity extracted from documents to the documents, the document linking task for assigning a relation between entities extracted from documents to the documents, and the document recommendation task for recommending a document based on the similarity of entities extracted from documents.

The determination unit 31 determines whether to perform the validation request to the user according to a task that is being executed by the user, when the validation drive event is generated.

Since the validation may impart a load to the user, even a cooperative user may be unable to perform the validation depending on a timing. For example, when the user is executing a work of registering a document in the document DB 20, the user is motivated to register keywords in the knowledge base 30. Meanwhile, when the user is executing a work of searching the document DB 20 for documents, the user may not be motivated to register keywords in the knowledge base 30 because the user needs to find documents quickly. Accordingly, the determination unit 31 estimates the user's work from the task requested by the user to the document management device 10, and determines whether to request the validation according to the type of the work.

For example, when the task requested by the user to the document management device 10 is the document tagging task or the document linking task, the determination unit 31 determines that the user is executing the work of registering a document in the document DB 20, and requests the validation. Meanwhile, when the task requested by the user to the document management device 10 is the document recommendation task, the determination unit 31 determines that the user is executing the work of searching the document DB 20 for a document, and does not request the validation.

In the present exemplary embodiment, the process of the determination unit 31 is performed as an example of a process of determining whether to output the difference information to the user based on a type of a work of the user. Further, in the present exemplary embodiment, the process of the determination unit 31 is performed as an example of a process of estimating the work of the user based on the specific process requested by the user.

The calculator 32 calculates the degree of contribution of each candidate keyword extracted by the extraction unit 21 and stored in the candidate keyword storage unit 22, to the task. In order to calculate the degree of contribution, in the present exemplary embodiment, it is assumed that the contribution of the specific information of the knowledge base 30 to the execution result of the task may be evaluated. For example, when a tag “political science” is assigned to a document, it may be determined that the tag is assigned because a candidate keyword “Washington” in the document is defined as “politician” in the knowledge base 30.

When an extracted candidate keyword and the attribute of the candidate keyword do not contribute to the task, the effect of the candidate keyword is relatively small even though the validation is performed despite the load. For example, when a candidate keyword “spontaneous symmetry breaking” is extracted, it may be found that the number of documents including the candidate keyword is small, and the effect of the candidate keyword is small. Further, for a candidate keyword “Feynman”, when an attribute “Bongo player” with a relatively low degree of contribution is extracted instead of an attribute “Physicist” with a relatively high degree of contribution, the effect of the candidate keyword may also be found to be small.

Accordingly, the calculator 32 calculates the degree of contribution of the extracted candidate keyword to the task. Here, as the method of calculating the degree of contribution of the candidate keyword to the task, for example, the following two calculation methods may be used. A first calculation method is a calculation method used when the correct answer of each task is known. For the document tagging task, the document linking task, or the document recommendation task, when the first calculation method is used, the calculator 32 may use, for example, the number of documents for which a new and appropriate tagging, linking, or recommendation is performed when a candidate keyword is added to the knowledge base 30, as the degree of contribution to the task. A second calculation method is a calculation method used when the correct answer of each task is unknown. For the document tagging task, when the second calculation method is used, the calculator 32 may use, for example, the number of documents to which a tag is newly assigned when a candidate keyword is added to the knowledge base 30, as the degree of contribution to the task. For the document linking task, the calculator 32 may use, for example, the number of documents to which a link is newly assigned when a candidate keyword is added to the knowledge base 30, as the degree of contribution to the task. For the document recommendation task, the calculator 32 may use, for example, the number of documents which are newly recommended or the number of users to which documents are newly recommended when a candidate keyword is added to the knowledge base 30, as the degree of contribution to the task.

In the present exemplary embodiment, the degree of contribution is used as an example of a degree of importance of the modification of the knowledge base in the specific process. Further, in the present exemplary embodiment, the process of the calculator 32 is performed as an example of a process of determining a degree of importance based on the magnitude of the influence of the modification of the knowledge base on the result of the specific process.

The contribution information storage unit 33 stores information in which each candidate keyword stored in the candidate keyword storage unit 22 is associated with the degree of contribution to the task that is calculated by the calculator 32 for the candidate keyword (hereinafter, referred to as “contribution information”).

The generator 34 extracts each candidate keyword included in the contribution information stored in the contribution information storage unit 33 in a descending order of the degree of contribution associated with the candidate keyword. Then, the difference information generation unit 34 generates information representing a difference between a result of the task executed using the knowledge base 30 before the candidate keyword is added, and a result of the task executed using the knowledge base 30 to which the candidate keyword is added (hereinafter, referred to as “difference information”).

When the user is not aware of the effect resulting from the addition of the candidate keyword to the knowledge base 30, the user is unable to determine, in the validation, that the candidate keyword is to be added to the knowledge base 30. For example, the following three cases may be considered to correspond to the case where the user is unable to determine that the candidate keyword needs to be added to the knowledge base 30 in the validation. A first case is, for example, a case where documents to which a tag is to be assigned when a candidate keyword “influencer” is added are unknowable. A second case is, for example, a case where when a candidate keyword “new coronavirus” is added, it is unclear whether “corona” in the candidate keyword is correctly distinguishable from “corona” of “sun corona”. A third case is, for example, a case where it is unknown what a merit of modifying the attribute of a candidate keyword “Einstein” from “scientist” to “physicist” is.

Accordingly, the generator 34 generates the difference information of the execution results of the task before and after a candidate keyword is added to the knowledge base 30. Here, for the document tagging task, the difference information may be, for example, another document to which a tag is newly assigned when a candidate keyword is added to the knowledge base 30. For the document linking task, the difference information may be, for example, another document to which a link is newly assigned when a candidate keyword is added to the knowledge base 30. For the document recommendation task, the difference information may be, for example, another document which is newly recommended to the user when a candidate keyword is added to the knowledge base 30.

In the present exemplary embodiment, the process of the generator 34 is performed as an example of a process of acquiring the difference information that represents the difference between the result of executing the specific process using the pre-modified knowledge base and the result of executing the specific process using the modified knowledge base. Further, in the present exemplary embodiment, another document to which a tag is newly assigned, another document to which a link is newly assigned, and another document which is newly recommended to the user are used as examples of the difference information that represents an amount by which the result of executing the specific process using the expanded knowledge base is increased from the result of executing the specific process using the pre-expanded knowledge base.

The output unit 35 outputs the candidate keywords extracted by the generator 34 in the descending order of the degree of contribution and the difference information generated by the generator 34, to the display device 15 (see FIG. 2). As a result, the display device 15 displays the candidate keywords and the difference information.

In the present exemplary embodiment, the process of the output unit 35 is performed as an example of a process of outputting the difference information to the user. Further, in the present exemplary embodiment, the process of the output unit 35 is also performed as an example of a process of outputting the difference information based on the degree of importance of the modification of the knowledge base in the specific process. Further, in the present exemplary embodiment, the process of the output unit 35 is also performed as an example of a process of outputting the difference information in descending order of the degree of importance of the modification of the knowledge base in the specific process.

The acquisition unit 36 acquires a feedback input by the user for the candidate keyword and the difference information displayed on the display device 15 (see FIG. 2), representing the validity of the addition of the candidate keyword to the knowledge base 30 and the validity of the candidate keyword.

When the candidate keyword extracted from the document is not valid, an appropriate feedback may not be acquired from the user. This corresponds to, for example, a case where “spontaneous symmetry” is extracted, but the “spontaneous symmetry breaking” is valid as a candidate keyword. Further, when there exists a more effective attribute than the attribute of the extracted candidate keyword, an appropriate feedback may not also be acquired from the user. This corresponds to, for example, a case where an attribute “human” is extracted for the candidate keyword “Einstein”, but an attribute “physicist” is more effective.

Accordingly, in addition to a first operation of acquiring a feedback input by the user, which selects “YES” or “NO” that represents whether the candidate keyword needs to be added to the knowledge base 30, the acquisition unit 36 performs second to fourth operations. The second operation is an operation of acquiring a feedback input by user, in which the user designates a range of a valid candidate keyword when a feedback which selects “NO” in the first operation is acquired. The third operation is an operation of acquiring a feedback input by the user, in which the user selects an attribute of a valid candidate keyword from the candidates when a feedback which selects “NO” in the first operation is acquired. Here, as the attribute presented as a candidate, an attribute already registered in the knowledge base 30 may be used. The fourth operation is an operation of acquiring a feedback input by the user, in which the user freely describes a valid candidate keyword or attribute thereof when a feedback which selects “NO” in the first operation is acquired. Then, when the second to fourth operations are performed, the acquisition unit 36 corrects the candidate keyword or attribute of the candidate keyword stored in the candidate keyword storage unit 22 according to the acquired feedback. As a result, the corrected candidate keyword or attribute of the corrected candidate keyword that is stored in the candidate keyword storage unit 22 is reevaluated by the calculator 32, the generator 34, the output unit 35, and the acquisition unit 36.

In the present exemplary embodiment, a feedback is used as an example of information input by the user about the validity of the modification of the knowledge base. Further, in the present exemplary embodiment, the process of the acquisition unit 36 is performed as an example of a process of determining whether to modify the knowledge base according to the information input by the user about the validity of the modification after the difference information is output to the user.

Further, the functional units are implemented in the form that software resources and hardware resources cooperate with each other. Specifically, the functional units are implemented in the form that the processor 11 (see FIG. 2) reads a program for implementing the functional units from, for example, the HDD 13 (see FIG. 2) to the main memory 12 (see FIG. 2) and executes the program.

### Operation of Document Management Device

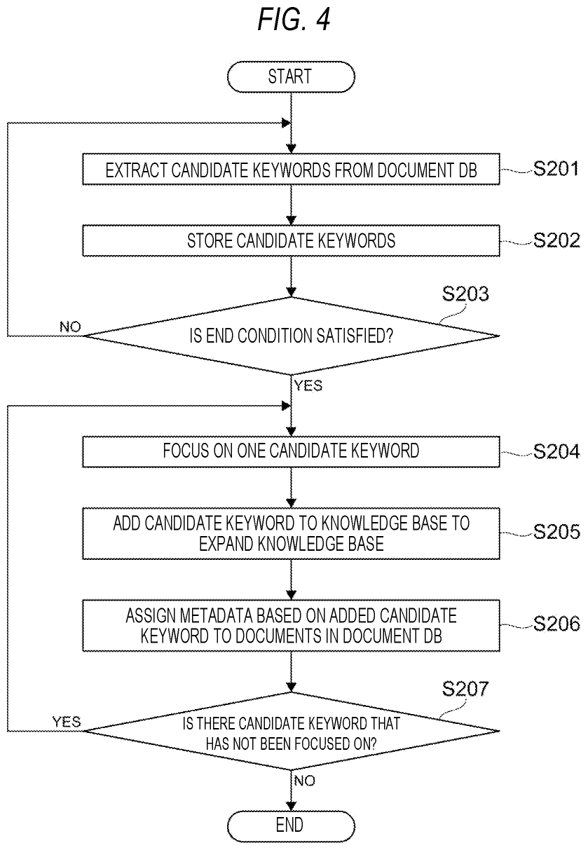

FIG. 4 is a flowchart illustrating an example of the operation when the knowledge base 30 of the document management device 10 is expanded according to the present exemplary embodiment. The operation may be performed when a new document is registered in the document DB 20 or at a predetermined timing.

As illustrated, in the document management device 10, first, the extraction unit 21 extracts candidate keywords to be added to the knowledge base 30, from the documents stored in the document DB 20 (step 201). Then, the extraction unit 21 stores the candidate keywords extracted in step 201 in the candidate keyword storage unit 22 (step 202).

Then, the extraction unit 21 determines whether an end condition for ending the extraction of candidate keywords is satisfied (step 203). Here, the end condition may be a condition that all keywords that are not registered in the knowledge base 30 are extracted, or a condition that a predetermined number of keywords that are not registered in the knowledge base 30 are extracted.

As a result, when it is determined that the end condition is not satisfied, the extraction unit 21 returns the process to step 201.

Meanwhile, when it is determined that the end condition is satisfied, the extraction unit 21 proceeds to the process of step 204.

As a result, the expansion unit 23 starts the operation. At this time, the expansion unit 23 starts the operation when it is notified that all of the candidate keywords have been evaluated by a process to be described later. When the operation is started, the expansion unit 23 focuses on one candidate keyword stored in the candidate keyword storage unit 22 (step 204). At this time, a candidate keyword associated with information indicating that a reevaluation is necessary by a process to be described later is excluded. When the candidate keyword is focused in step 204, the expansion unit 23 adds the focused candidate keyword to the knowledge base 30 so as to expand the knowledge base 30 (step 205). When the knowledge base 30 is expanded in step 205, the task execution unit 24 executes the task for assigning metadata (for example, tags or links) to the documents in the document DB 20 based on the candidate keyword added to the knowledge base 30 (step 206).

Then, the expansion unit 23 determines whether there is a candidate keyword that has not been focused on among the candidate keywords stored in the candidate keyword storage unit 22 (step 207).

As a result, when it is determined that there is a candidate keyword that has not been focused on, the expansion unit 23 returns the process to step 204.

Meanwhile, when it is determined that there is no candidate keyword that has not been focused on, the expansion unit 23 ends the process.

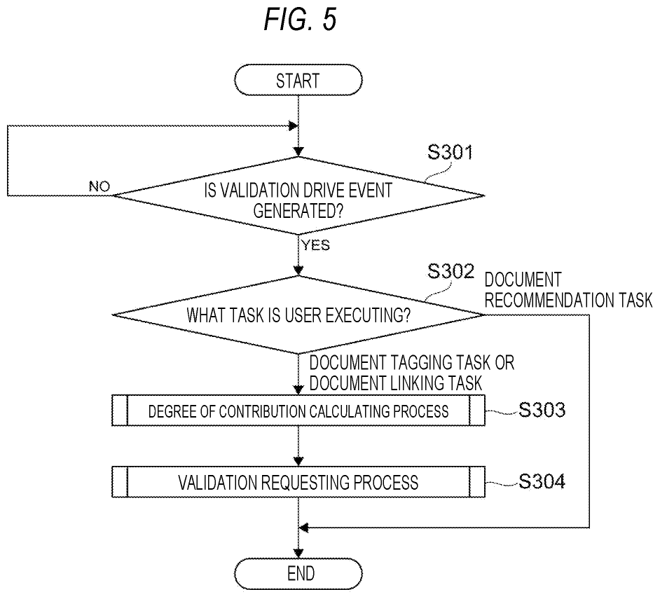

FIG. 5 is a flowchart illustrating an example of an operation performed when the user of the document management device 10 is caused to perform the validation according to the present exemplary embodiment.

As illustrated, in the document management device 10, first, the determination unit 31 determines whether the user has generated the validation drive event (step 301).

As a result, when it is determined that the user has not generated the validation drive event, the determination unit 31 repeats step 301.

Meanwhile, when it is determined that the user has generated the validation drive event, the determination unit 31 evaluates the task that is being executed by the user (step 302).

As a result, when it is determined that the task that is being executed by the user is the document tagging task or the document linking task, the calculator 32 performs the degree of contribution calculating process (step 303). Then, the generator 34, the output unit 35, and the acquisition unit 36 perform the validation requesting process (step 304).

Meanwhile, when it is determined that the task that is being executed by the user is the document recommendation task, the determination unit 31 ends the process without performing the degree of contribution calculating process in step 303 and the validation requesting process in step 304.

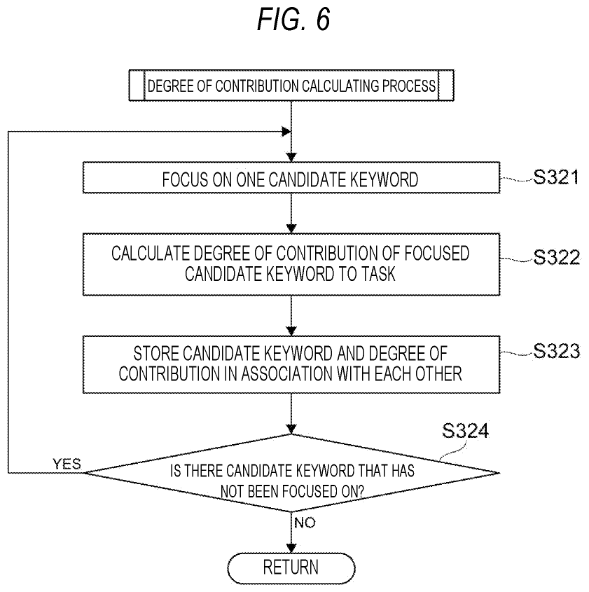

FIG. 6 is a flowchart illustrating the flow of the degree of contribution calculating process in step 303 of FIG. 5.

When the degree of contribution calculating process is started, first, the calculator 32 focuses on one candidate keyword stored in the candidate keyword storage unit 22 (step 321).

Next, the calculator 32 calculates the degree of contribution of the candidate keyword focused in step 321 to the task (step 322).

Next, the calculator 32 associates the candidate keyword focused in step 321 with the degree of contribution calculated in step 322, and stores the associated candidate keyword and degree of contribution as the contribution information in the contribution information storage unit 33 (step 323).

Then, the calculator 32 determines whether there is a candidate keyword that has not been focused on among the candidate keywords stored in the candidate keyword storage unit 22 (step 324).

As a result, when it is determined that there is a candidate keyword that has not been focused on, the calculator 32 returns the process to step 321.

Meanwhile, when it is determined that there is no candidate keyword that has not been focused on, the calculator 32 returns the process to FIG. 5.

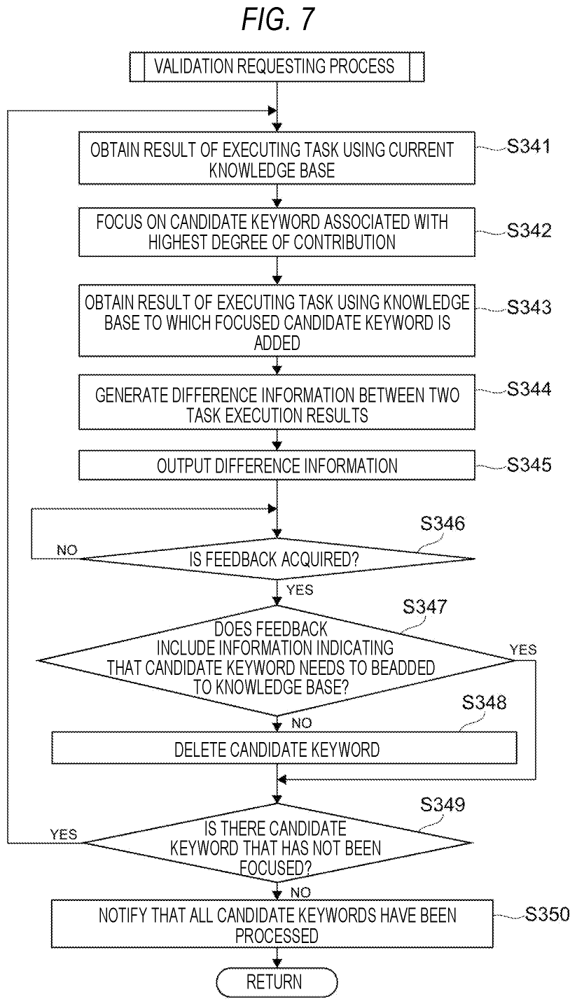

FIG. 7 is a flowchart illustrating the flow of the validation requesting process in step 304 of FIG. 5.

When the validation requesting process is started, first, the generator 34 requests the result of the task executed using the current knowledge base 30 (step 341).

Meanwhile, the generator 34 focuses on a candidate keyword associated with the highest degree of contribution, among the unfocused candidate keywords included in the contribution information stored in the contribution information storage unit 33 (step 342).

Then, the generator 34 requests the result of the task executed using the knowledge base 30 to which the candidate keyword focused in step 342 is added (step 343).

Next, the generator 34 generates the difference information indicating the difference between the task execution result requested in step 341 and the task execution result requested in step 343 (step 344).

Then, the output unit 35 outputs the difference information generated in step 344 to the display device 15 (see FIG. 2) (step 345).

As a result, the acquisition unit 36 determines whether a feedback has been acquired from the user (step 346).

As a result, when it is determined that the feedback has not been acquired from the user, the acquisition unit 36 repeats step 346.

Meanwhile, when it is determined that the feedback has been acquired from the user, the acquisition unit 36 determines whether the feedback acquired in step 346 includes information indicating that the candidate keyword focused in step 342 needs to be added to the knowledge base 30 (step 347).

As a result, when it is determined that the feedback does not include the information indicating that the candidate keyword needs to be added to the knowledge base 30, the acquisition unit 36 deletes the candidate keyword focused in step 342 from the candidate keywords stored in the candidate keyword storage unit 22 (step 348). Alternatively, when it is determined that the feedback includes information indicating that the candidate keyword needs to be corrected, the feedback acquisition unit 36 may correct the candidate keyword rather than deleting the candidate keyword, and associate the corrected candidate keyword with information indicating that the corrected candidate keyword needs to be reevaluated.

Then, the acquisition unit 36 determines whether there is a candidate keyword that has not been focused on, among the candidate keywords included in the contribution information stored in the contribution information storage unit 33 (step 349).

As a result, when it is determined that there is a candidate keyword that has not been focused on, the acquisition unit 36 returns the process to step 341.

Meanwhile, when it is determined that there is no candidate keyword that has not been focused on, the acquisition unit 36 notifies to the expansion unit 23 that all of the candidate keywords have been processed (step 350), and returns the process to FIG. 5.

### Modifications

Although not described above, the document management device 10 may be configured to evaluate a degree of contribution of the user to the expansion of the knowledge base 30.

When the knowledge base 30 is expanded, the document management device 10 may be unable to determine the user to whom the validation is to be requested. For example, when the candidate keyword “spontaneous symmetry breaking” is extracted, only a limited user is able to correctly determine whether the candidate keyword needs to be added to the knowledge base 30. Further, when the validation is requested to a user who has no incentive to expand the knowledge base 30, the user experience is reduced.

Accordingly, the document management device 10 may evaluate a domain of a user and a user's willingness for expanding the knowledge base 30 based on a user's past performance for expanding the knowledge base 30, and reflect the evaluation result in selecting a user when the validation request is performed next. For example, the document management device 10 records the user who performs the validation when the knowledge base 30 is expanded. Then, the document management device 10 performs a profiling by evaluating the domain in which the user is cooperative with the validation. Here, for estimating the domain, a category of an added keyword or the similarity with other keywords may be used. Further, the document management device 10 evaluates the degree of contribution of the user based on the number of added keywords or the use frequency. As a result, when a validation of a new keyword is requested, a user who is highly motivated with a matching domain is selected.

Although not described above, the document management device 10 may determine whether to add a candidate keyword to the knowledge base 30, based on statistical information of feedbacks.

The determination as to whether a candidate keyword needs to be added to the knowledge base 30 may vary depending on users. For example, it may be considered that some users may think that the candidate keyword “new coronavirus” is useful as a news tag, and other users may think that the candidate keyword should not be registered until the keyword is finalized.

Accordingly, the document management device 10 may determine a validation result from statistical information of feedbacks from plural users. For example, when 80% or more of users to which the validation is requested agree with the registration, the registration of the candidate keyword “new coronavirus” in the knowledge base 30 may be determined.

### Processor

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Program

The process performed by the document management device 10 of the present exemplary embodiment is prepared in a form of, for example, a program such as application software or the like.

That is, the program implementing the present exemplary embodiment may be considered as a program that causes a computer to implement (a) a function of, in modifying a knowledge base that has accumulated various types of knowledge information when knowledge information required for a specific process requested by a user does not correspond to the knowledge accumulated in the knowledge base, acquiring difference information that represents a difference between (i) a result of executing the specific process using the pre-modified knowledge base and (ii) a result of executing the specific process using a modified knowledge base, and (b) a function of outputting the acquired difference information to the user.

Further, the program for implementing the present exemplary embodiment may be provided through a communication line, or may be provided in a state of being stored in a recording medium such as a CD-ROM or the like.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information outputting device comprising:
a processor configured to:
in modifying a knowledge base that has accumulated various types of knowledge information when knowledge information required for a specific process requested by a user does not correspond to the knowledge accumulated in the knowledge base, acquire difference information that represents a difference between (i) a result of executing the specific process using the pre-modified knowledge base and (ii) a result of executing the specific process using a modified knowledge base; and
output the acquired difference information to the user.

2. The information outputting device according to claim 1, wherein the modifying of the knowledge base comprises expanding the knowledge base by adding a term and an attribute of the term to the knowledge base.

3. The information outputting device according to claim 2, wherein the difference information comprises information that represents an amount by which the result of executing the specific process using an expanded knowledge base is increased from the result of executing the specific process using the pre-expanded knowledge base.

4. The information outputting device according to claim 1, wherein the difference information comprises information obtained by comparing the result of executing the specific process using the pre-modified knowledge base and the result of executing the specific process using the modified knowledge base.

5. The information outputting device according to claim 1, wherein
the processor is configured to output the difference information based on a degree of importance of the modifying in the specific process.

6. The information outputting device according to claim 5, wherein
the processor is configured to determine the degree of importance based on a magnitude of an influence of the modifying on the result of the specific process.

7. The information outputting device according to claim 5, wherein
the processor is configured to output the difference information in a descending order of the degree of importance.

8. The information outputting device according to claim 1, wherein
the processor is configured to determine whether to output the difference information to the user, based on a type of a work of the user.

9. The information outputting device according to claim 8, wherein
the processor is configured to estimate the work of the user based on the specific process requested by the user.

10. The information outputting device according to claim 1, wherein
the processor is configured to determine whether to modify the knowledge base, according to an input of information on a validity of the modifying determined by the user after the difference information is output to the user.

11. A non-transitory computer readable medium storing a program that causes a computer to execute information output processing, the information output processing comprising:
in modifying a knowledge base that has accumulated various types of knowledge information when knowledge information required for a specific process requested by a user does not correspond to the knowledge accumulated in the knowledge base, acquiring difference information that represents a difference between (i) a result of executing the specific process using the pre-modified knowledge base and (ii) a result of executing the specific process using a modified knowledge base; and
outputting the acquired difference information to the user.

12. An information outputting device comprising:
acquiring means for, in modifying a knowledge base that has accumulated various types of knowledge information when knowledge information required for a specific process requested by a user does not correspond to the knowledge accumulated in the knowledge base, acquiring difference information that represents a difference between (i) a result of executing the specific process using the pre-modified knowledge base and (ii) a result of executing the specific process using a modified knowledge base; and
outputting means for outputting the acquired difference information to the user.
